(19) United States
(12) Patent Application Publication
(10) Pub. No.: US 2014/0020436 A1
(43) Pub. Date: Jan. 23, 2014

(54) REFUSE CONTAINER LOCK WITH LOCKING CYLINDER

(71) Applicant: Manfred Matuschek, Solingen (DE)

(72) Inventor: Manfred Matuschek, Solingen (DE)

(21) Appl. No.: 13/946,647

(22) Filed: Jul. 19, 2013

(30) Foreign Application Priority Data
Jul. 19, 2012 (DE) 102012106531.4

(51) Int. Cl. E05B 65/52

(52) U.S. Cl. CPC E05B 65/52
USPC 70/158

(57) ABSTRACT

A refuse container lock having a latch that is mounted in a lock housing and includes a latch head and a latch tail, such that the latch head in a closed position grasps behind a hook of a counterlocking part and can be brought into a release position by tipping the lock housing from an upright position into a tipped position or by actuating a locking cylinder and by the action of a locking cam of the locking cylinder upon the latch head that is coupled to the latch tail held immovably in the upright position so as to pivot contrary to an elastic return force. For refinements that are advantageous to the user, it is proposed that the locking cylinder should be situated in the lock housing and that the locking cam should act on an actuation arm extending down from the latch head.

### FIELD OF THE INVENTION

The invention relates to a refuse container lock having a latch that is disposed in a lock housing and that comprises a latch head and a latch tail, such that the latch head in a closed position catches behind a hook of a counterlocking part and can be moved into a release position by tipping the lock housing from an upright position into a tipped position or by actuating a locking cylinder and by the action of a locking cam of the locking cylinder upon the latch head that is coupled to the latch tail held immovably in the upright position so as to pivot contrary to an elastic return force.

### BACKGROUND OF THE INVENTION

A lock of this type is described in patent DE 10 2007 039 351 A1. The lock includes a lock housing, which is disposed on the upper border of a refuse container that can be closed with a cover. Situated inside the lock housing is an opening slide with mass, which assumes a lower position inside the lock housing when the refuse container is in an upright position. Said opening slide has a guide groove in which a guide pin of the latch tail engages. If the refuse container is tipped so that the cover opens, then the opening slide is displaced inside the housing and rotates the latch tail. A latch head, which is coupled onto the latch tail, has a locking arm on whose end a locking stud is situated. In closed position, the locking stud catches behind a hook of a counterlocking part fastened on the cover of the refuse container. Upon tipping the lock housing, the latch is moved into a release position, in which the latch head no longer catches behind the hook of the counterlocking part, so that the container cover can open. The counterlocking part bears a locking cylinder with a locking cam. If the locking cam is rotated, the latch head is pivoted into its release position. In this case it executes a relative motion with respect to the latch tail. That is, it is pivoted with respect to the latch tail contrary to the return force of a spring. If the locking cylinder is rotated back from an open position to a closed position, then the spring, which is untensing and acting on the latch head, ensures that the latch head pivots back into its catching-behind position.

In a refuse container lock described in DE 692 01 000 T2, a rigid latch can likewise be moved into a release position by an opening slide that can slide when the lock housing is tipped. With the lock housing in upright position, the opening slide can also be displaced by the locking cam of a locking cylinder, so that the cover can be opened.

Patent DE 299 03 911 U1 describes a refuse container lock with a slide bolt, which can be converted from a locked position into a release position both by a pivot weight and by a locking cylinder.

In a refuse container lock described in DE 197 08 193 A1, the hook of the counterlocking part can be brought into a locked position by actuating a locking cylinder.

Patent DE 201 01 187 U1 describes a refuse container lock with a gravity-operated opening mechanism, which can also be opened by using a key.

In the refuse container lock described in DE 10 2004 007 862 A1, a locking cylinder for manually opening the lock is situated on the cover.

Disclosed in DE 198 33 890 C1 is a refuse container with gravimetrically unlockable lock, which can be opened both by key actuation and with the help of an unlocking tool without key.

Patent WO 2005/111348 A1 describes a lock that opens automatically by tipping of a refuse container as the result of gravitational effect and that, in addition, can be opened by rotating a locking cylinder, said locking cylinder being disposed in the lock housing.

### SUMMARY OF THE INVENTION

It is the object of the present invention to further develop the generic refuse container lock in a manner advantageous to the user.

The object is fulfilled by means of the invention indicated in the claims.

As a result of the inventive solution, the locking cylinder no longer needs to be incorporated in the counterlocking part. The counterlocking part can thus be of simpler configuration. It is sufficient to configure it as an angular sheet that is only required to be screwed onto the underside of the housing cover. It becomes possible to dispense with an independent housing, in which a locking cylinder must be incorporated in the counterlocking part, because the locking cylinder is now situated inside the lock housing.

As a result of the inventive solution, intervention in the mechanism that has proven itself in the generic lock can be kept to a minimum. The latch head receives an additional arm, on which the locking cam acts. The latch tail can therefore be rotated by a gravity-powered opening slide upon tipping of the lock housing. With the lock housing in the upright position, the latch tail, in the proven manner, is kept in a position that holds the latch in the closed position. When the locking cylinder is actuated, the latch head is pivoted with respect to the latch tail. It thereby reaches a release position in which the cover of the upright-standing refuse container can be opened. The elastic return force can be generated by a pressure spring connected with the latch body. The return force holds a stop of the latch head against a counterstop of the latch tail. When opening is actuated by tipping of the refuse container lock, the latch behaves like a rigid body. The pre-tensed spring, however, is compromised if the refuse container lock is intended to be opened by actuation of the locking cylinder. Then the latch head pivots with respect to the latch tail, which is held stationary. In a preferred embodiment, the refuse container lock has an actuation slide. Said slide is moved upon actuation of the locking cylinder by the locking cam. It impacts a of the actuation arm. The locking cam thus acts directly on the actuation arm. The actuation arm moves at an angle to a locking arm on whose end a bolt stud can be situated that, in closed position, catches behind the hook of the counterlocking part. In a preferred embodiment, the two arms of the latch head run essentially diagonally to one another. The pivot axis about which the latch rotates upon tipping of the lock housing is preferably connected immovably with the lock housing. The two bearing shells, which configure the lock housing, can comprise bearing openings for this purpose. The pivot axis about which the latch head can pivot with respect to the latch tail, is preferably in the immediate vicinity of the rotary axis. The actuation slide and opening slide can be movable in parallel with one another. Both slides are fed through the lock housing. For this purpose, the two housing shells can comprise guide ribs or guide grooves. The actuation slide can be directly impacted by the eccentric cam. The actuation slide is preferably displaced against the force of a return spring. The actuation slide can comprise a pocket into which the free end of the actuation arm engages.

### BRIEF DESCRIPTION OF THE DRAWINGS

An embodiment of the invention is explained hereinafter with reference to the appended drawings, which are as follows.

FIG. 1 shows an assembled refuse container lock with associated counterlocking part, in a perspective view.

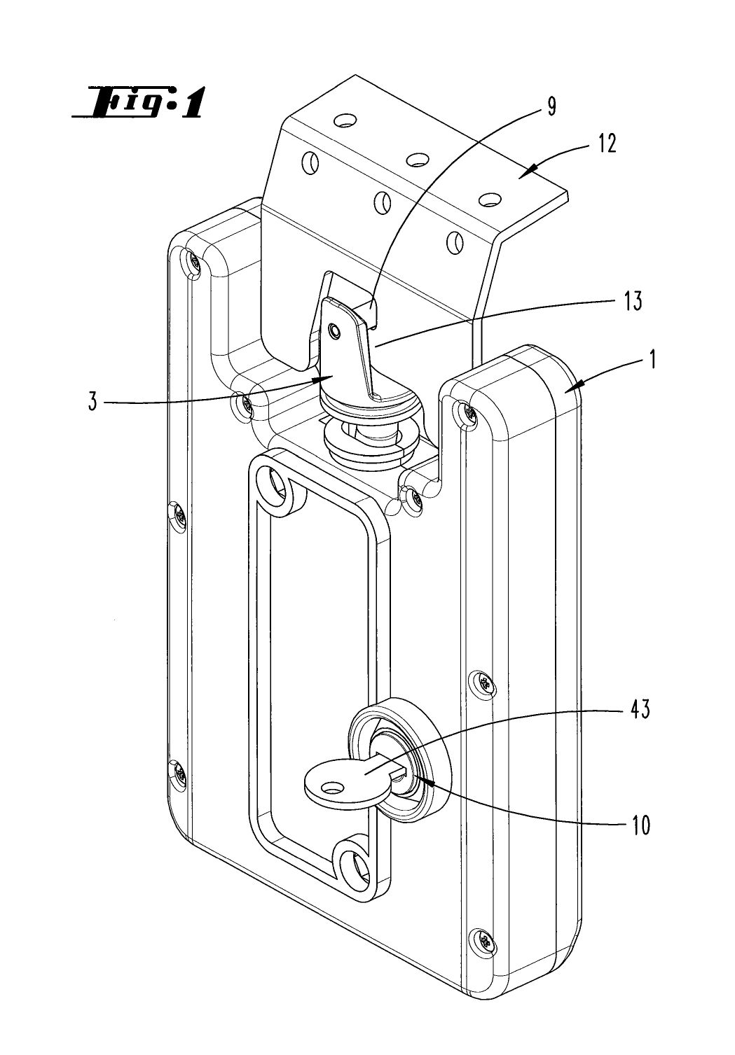

FIG. 2 shows the refuse container lock in opened state in the closed position.

FIG. 3 shows a section along the line III-Ill in FIG. 2.

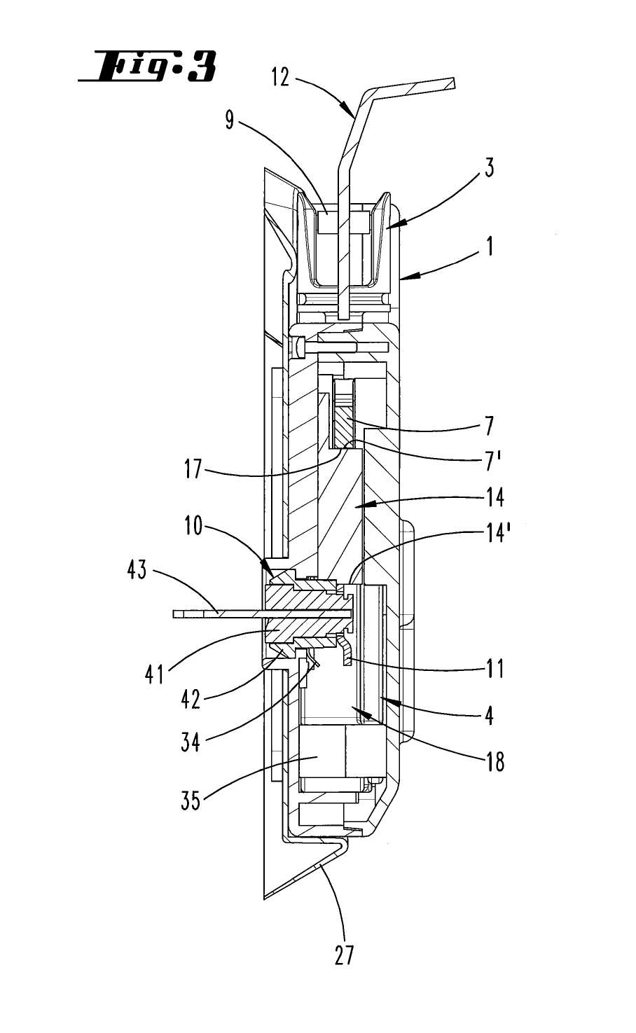

FIG. 4 shows a view as in FIG. 2 but with locking cylinder pivoted into an opening position, so that the latch assumes a release position.

FIG. 5 shows a section along the line V-V in FIG. 4.

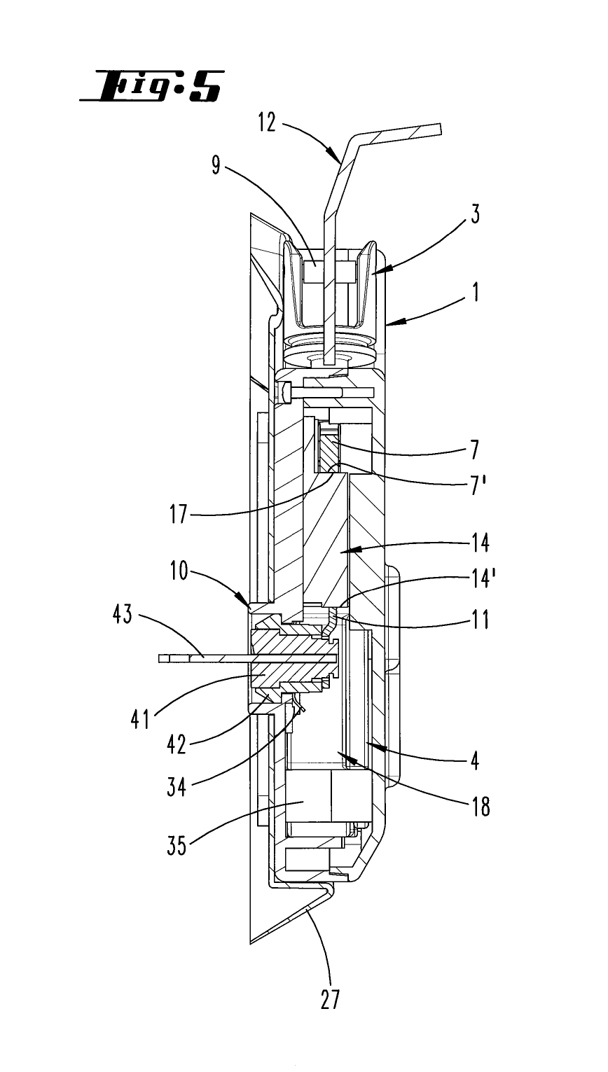

FIG. 6 shows a view according to FIG. 2 but with the latch in a gravity-powered release position in which an opening slide has shifted within the lock.

FIG. 7 shows a first explosion view of the refuse container lock.

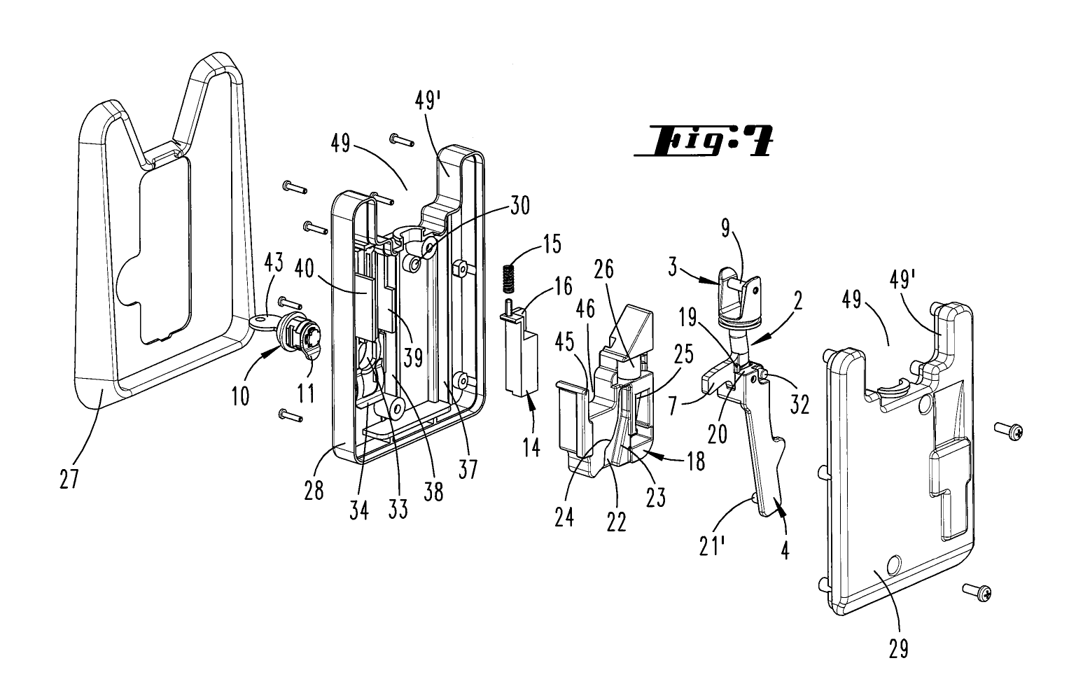

FIG. 8 shows a second explosion view of the refuse container lock.

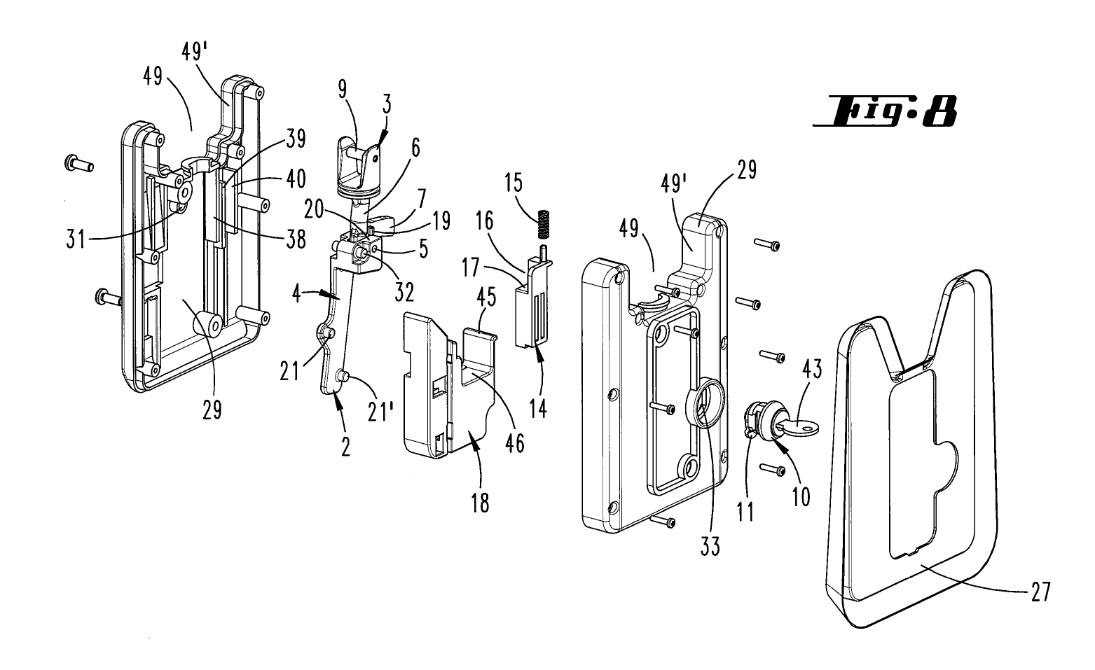

FIG. 9 shows an explosion view of the components of the locking cylinder.

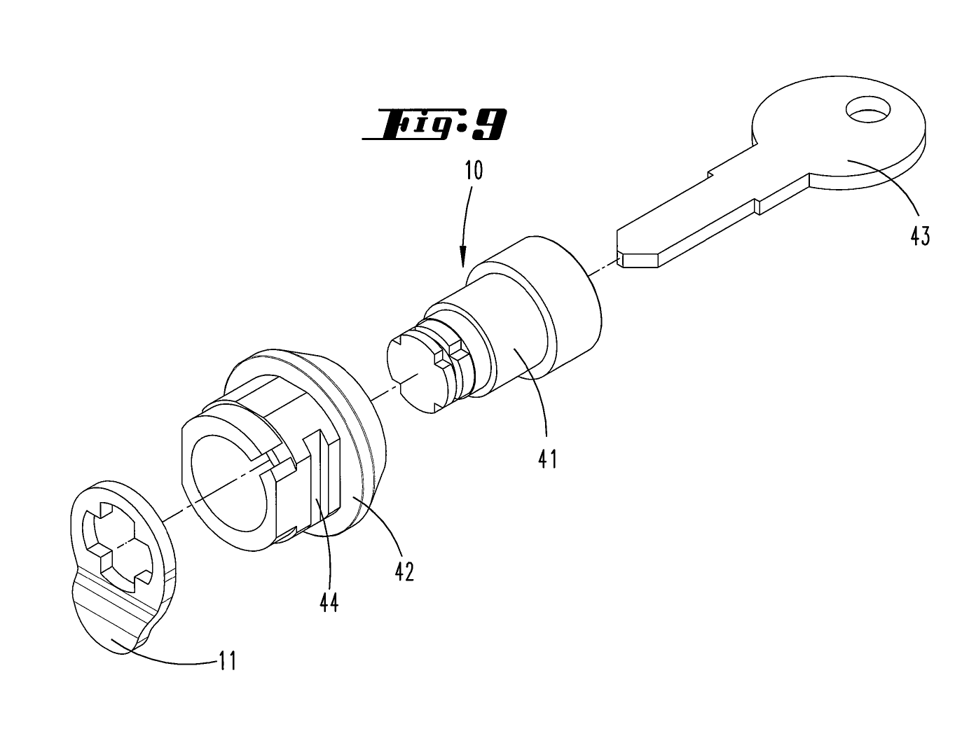

### DETAILED DESCRIPTION OF THE INVENTION

The lock housing 1 consists of two housing shells 28, 29 made of plastic or other suitable material, which can be screwed onto the upper border of a wall of a refuse container by using a bearing shell 27 as an intermediate layer.

The bearing shell 28 has a locking cylinder bearing opening 33, into which a cylinder housing 42 can be inserted. The cylinder bearing opening 33 is not round-shaped, so that the cylinder housing 42 is held torque-proof in the opening 33. Situated in a housing cavity of the cylinder housing 42 is a cylinder core 41, which cannot be rotated with respect to the cylinder housing 42 when the key 43 is not inserted. The cylinder core 41 does not allow itself to rotate with respect to the cylinder housing 42 until a matching key 43 has been inserted into the key slot of the cylinder core.

A locking cam 11 is situated on the end portion of the cylinder core 41 opposite the key slot. The locking cam 11 is an excenter that is in a torque-proof connection with the cylinder core 41. The cylinder housing 42 has grooves 44 into which a retaining clamp 34 can be inserted, said clamp holding the cylinder housing 42 on the bearing shell 28.

The two bearing shells have guide ribs 37, 38, 39, 40 in their bearing cavities. Between the guide ribs 37 and 38 there is an opening slide 18, which can slide inside the lock housing 1. Parallel to the motion direction of the opening slide 18, an actuation slide 14 is mounted so that it can slide inside the lock housing 1. The actuation slide 14 is mounted between the guide ribs 39 and 40.

While the opening slide 18 is freely movable within the lock housing 1, which means that it slides from an upright position to a tipped position by gravity acting on it during tipping of the lock housing 1, the actuation slide 14 is held in a defined operating position by a spring 15 supported on the lock housing 1. A front side 14′ of the actuation slide 14 is supported on the locking cam 11. The spring 15 situated opposite the front side 14′ pushes the actuation slide 14 against the locking cam 11.

A latch 2 is situated inside the lock housing 1. Said latch 2 consists of a latch tail 4 and a latch head 3. The latch tail 4 constitutes two bearing stumps that protrude in opposite directions from the latch tail 4 and form a rotary axis 32. Said bearing stumps engage in bearing openings 30, 31 of the two housing shells 28, 29 so that the latch 2 is mounted rotatably in the lock housing 1.

The latch tail 4 and the latch head 3 are joined together by a pivot axis 5. Contained in a bearing pocket of the latch tail 4 is a pressure spring 8, which exerts torque on the latch head 3. As a result, a stop 19 of the latch head 3 is spring-impacted adjacent to a counterstop 20 of the latch tail 4. In a non-impacted state the latch 2 thus behaves as a rigid body in which the latch head 3 is rigidly connected with the latch tail 4. However, if torque is exerted on the latch head 3 exceeding the spring tension of the spring 8, then the latch head 3 can pivot with respect to the latch tail 4.

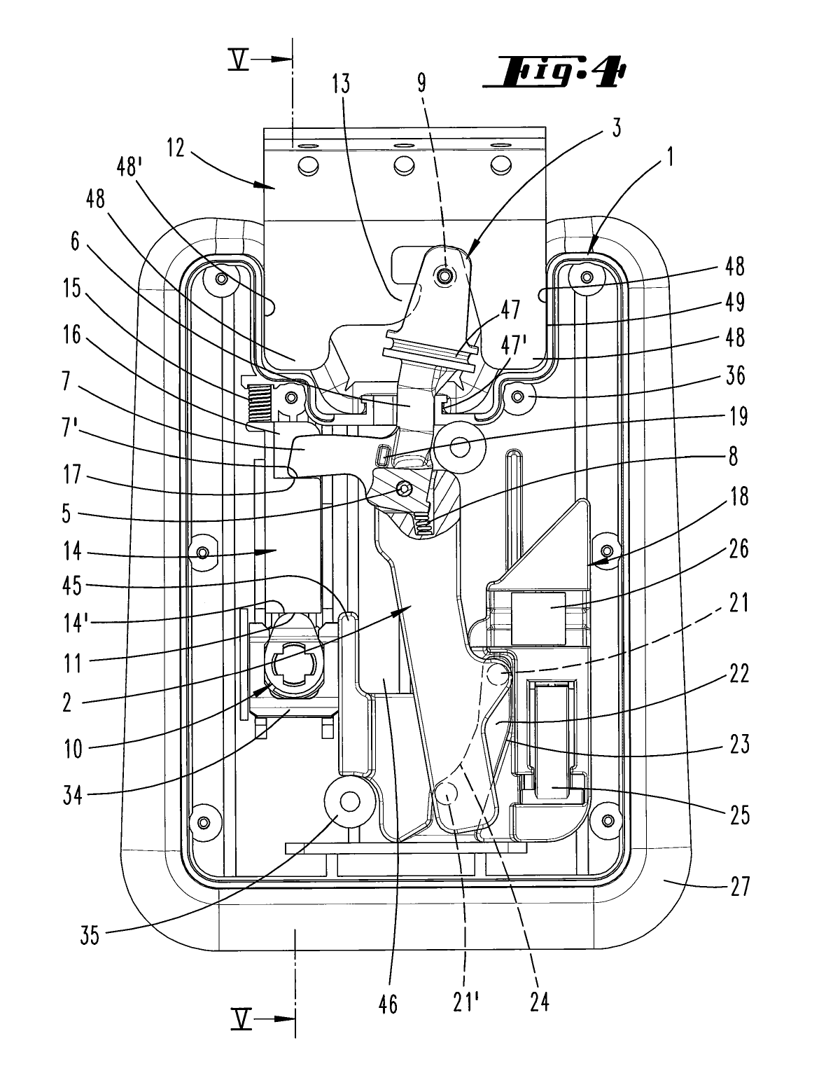

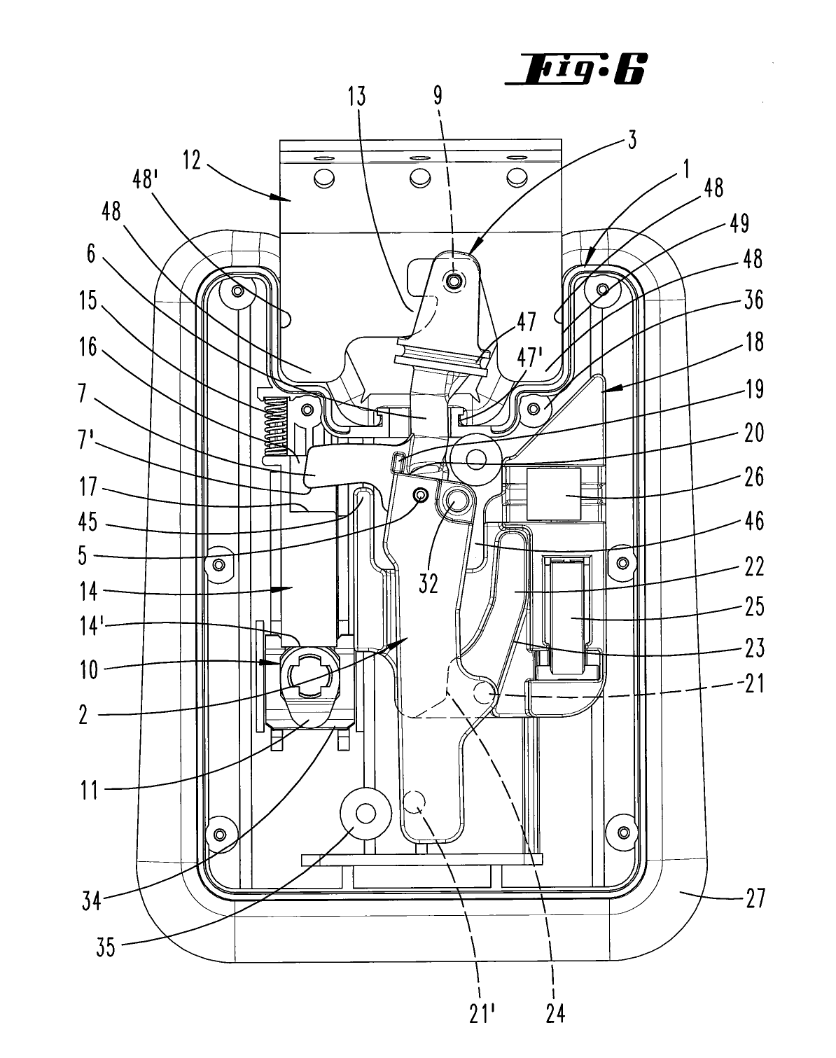

A control cam 21, protruding downward from the latch tail 4, engages in a control recess 22 of the broad side of the opening slide 18. The control recess 22 has two control curves 23, 24 situated opposite one another, which are configured in such a way that they hold the latch tail 4 torque-proof in the closed position illustrated in FIG. 4. The position shown in FIG. 4 is an upright position of the lock. If the lock is brought into tipped position, then the opening slide 18 moves into the release position indicated in FIG. 6. At the same time, the control cam 21 slides along the control curve 23, which is configured so that the latch 2, and especially the latch head 3 as well, are thereby pivoted.

The latch head 3 has a locking arm 6, which extends at an angle of approximately 180 degrees to the latch tail 4. A locking stud 9 is situated at the end of the locking arm 6, which protrudes out of the lock housing 1.

A counterlocking part 12 can be affixed on the cover of a refuse container. Said counterlocking part 12 is a stamped and bent piece. This is a steel sheet, which can be affixed on the refuse container cover with the aid of bolts or rivets protruding through the fastening openings. The simple-shaped counterlocking part 12 forms a hook 13, which in closed position is gripped by the locking stud 9. The hook 13 is configured as a catch-hook. It includes a sloped section, which, on locking of the refuse container cover, interacts with the locking stud 9 in such a way that the latch head 3 can move with respect to the stationary latch tail 4. In this process, the spring 8 is tensed. The spring 8 is untensed as soon as the locking stud 9 has passed over the hook 13. At that point the locking stud 9 is situated inside the hook enclosure.

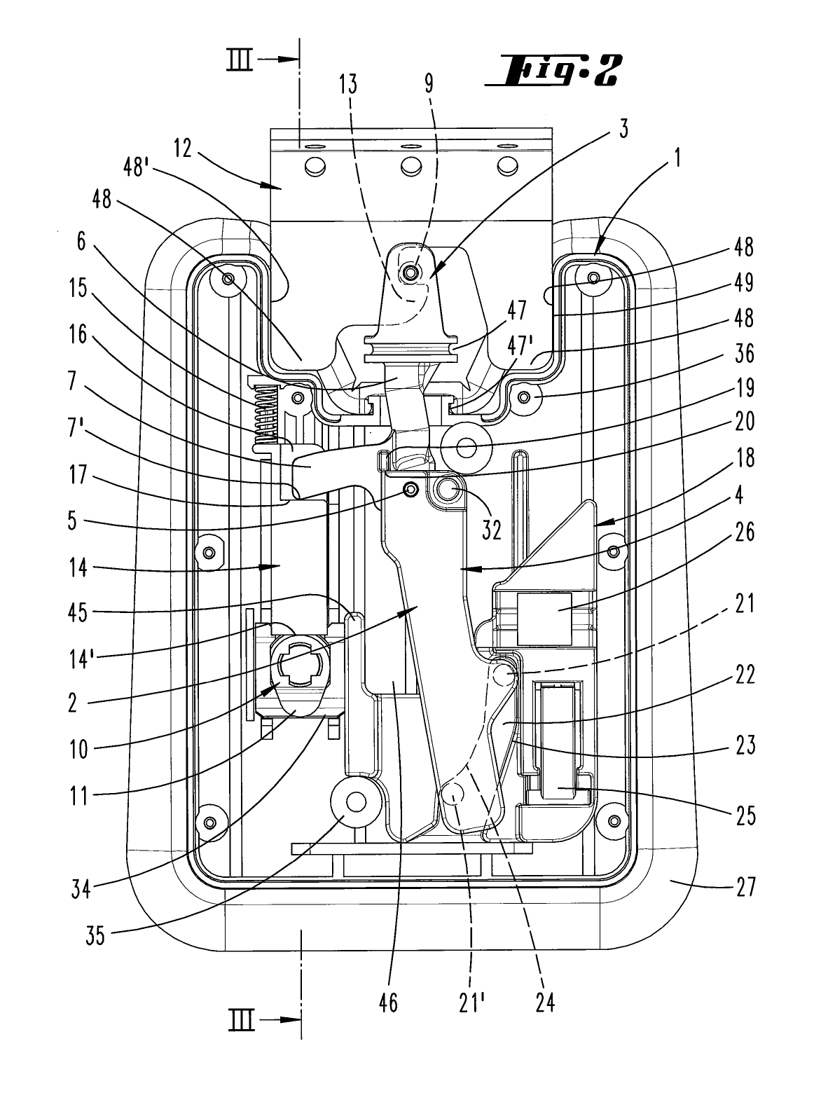

The latch head 2 has a laterally downward-protruding actuation arm 7, which configures an actuation 7′. A shoulder 17 of the actuation slide 14, which is situated opposite the front side 14′, acts on the actuation 7′. The length of the actuation slide 14 or the angle formed by the actuation arm 7 with respect to the locking arm 6, is measured in such a way that rotation of the locking cylinder 10 from the closed position shown in FIG. 2 to the release position shown in FIG. 4 leads to pivoting of the latch head 3 with respect to the latch tail 4, such that the pivot angle is sufficient to bring the locking stud 9 out of engagement with the hook 13. The locking cylinder 10 here must be rotated 180 degrees. The excenter portion of the locking cam 11 then moves below the front side 14′ of the actuation slide and holds it in a position moved upward. In the process, the spring 15 is tensed. The locking cylinder 10 must be willfully rotated back into the closed position shown in FIG. 2 in order to bring the latch head 3 back into its locked position.

The actuation slide 14 configures a pocket 16 on its side opposite the front side 14′, which is impacted by the locking cam 11. The floor of the pocket 16 forms the shoulder 17, which interacts with the 7′ of the actuation arm 7. The end of the actuation arm 7, which configures the 7′, is here contiguous with a side wall of the pocket 16. The angle-shaped edge of the pocket 16 has a centering pin on which the helical thread's pressure spring 15 is placed. The guide rib 39 has an angle-shaped recess through which the actuation arm 7 protrudes.

The opening slide 18 includes a recess 46, which is flanked by a protrusion 45 and into which the bearing portion of the latch 2 can dip when the opening slide 18 is switched into the release position shown in FIG. 6. The protrusion 45 here follows at a close distance the pivoting actuation arm 7. It is also capable, in theory, of acting on the actuation arm 7 for purposes of switching the latch head 3 into its release position.

With the refuse container lock, the blocking elements for operating errors 25, 26 in patent DE 10 2007 039 351 A1 were already described, and therefore reference is made here to those comments. These blocking elements for operating errors 25, 26 have the task of ensuring that the opening slide 18 is switched by gravitational power into the release position only when the lock housing is tipped about a particular tipping axis. If the lock housing is rotated about another axis, then the blocking elements for operating errors 25, 26 are switched into a blocked position by gravitational force, so that the opening slide 18 cannot move into the release position. The opening slide 18 is switched by gravitational force within the lock housing 1 only when the lock housing 1 is moved about the tipping axis from the upright position shown in FIG. 2 to the tipped position seen in FIG. 6. The resulting pivoting of the latch 2 has the effect that the latch head 3 assumes the release position shown in FIG. 6. If the lock is moved back into the upright position, then gravity slides the opening slide 18 back into the position shown in FIG. 2. In this position the latch head 3 can pivot with respect to the latch tail 4 either by locking of the refuse container cover or by key actuation.

The cam 21′ extending down from the latch tail 4 in the end area forms a blocking cam, which is contiguous with a portion of the control curve 24 in the operating positions illustrated in FIGS. 2 and 4. When the opening slide is slid into the operating position illustrated in FIG. 6, the blocking cam 21′ leaves the control curve 24, so that the latch 2 can rotate about the axis 32. On switching the opening slide 18 back into the position shown in FIG. 2 or 4, the blocking cam 21′ is impacted by a diagonal edge, so that the latch 2 is pivoted back into its starting position.

Reference number 47 or 47′ refers to recessed rings on the housing or on the latch head 3. The ends of a pleated hose can be clipped into these recessed rings to protect the inside of the housing 1 from dust. The pleated hose then surrounds the portion of the locking arm 6 extending out of the housing opening.

The portion of the counterlocking part 12 that configures the hook 13 forms two border portions 48′ that run parallel to one another. These two border portions 48′ end in continuations 48, which dip into a reception shaft 49 of the housing 1 when the refuse container cover closes. The two lateral walls 49′ of the reception shaft run parallel to one another. With the refuse container in closed position, the borders 48′ are contiguous with them. The corners of the continuations 48 or of the reception shaft 49 are rounded. On locking the refuse container cover, the roundings can meet one another so that the portion of the counterlocking part 12 that configures the continuations 48 can enter the reception shaft 49.

All disclosed features are (in themselves) essential to the invention. The disclosure of the application hereby also includes the entire disclosed content of the related/added priority documents (copy of the application), for the additional purpose of incorporating features of these documents into claims of the present application. The subsidiary claims, in their optionally attached version, characterize independent inventive refinements of the prior art, especially in order to make partial applications on the basis of these claims.

1. A refuse container lock having a latch that is mounted in a lock housing and comprises a latch head and a latch tail, such that the latch head in a closed position grasps behind a hook of a counterlocking part and can be brought into a release position by tipping the lock housing from an upright position into a tipped position or by actuating a locking cylinder and by the action of a locking cam of the locking cylinder upon the latch head that is coupled to the latch tail held immovably in the upright position so as to pivot contrary to an elastic return force, characterized in that the locking cylinder is situated in the lock housing and the locking cam acts on an actuation arm extending down from the latch head.

2. The refuse container lock according to claim 1 or in particular according to it, wherein the latch tail, upon tipping of the lock housing, is rotated by a gravity-powered opening slide and, with the lock housing in the upright position, is kept in a position that holds the latch in the closed position, such that the locking cylinder actuation pivots the latch head with respect to the latch tail.

3. The refuse container lock according to claim 1, wherein the elastic return force impacts a stop of the latch head against a counterstop of the latch tail.

4. The refuse container lock according to claim 1, characterized by an actuation slide that is fed in the lock housing and that, upon actuation of the locking cylinder, is slid by the locking cam and impacts a edge of the actuation arm.

5. The refuse container lock according to claim 1, wherein the latch head comprises a locking arm that interacts with the hook and that extends at an angled position to the direction in which the actuation arm extends.

6. The refuse container lock according to claim 1, wherein the actuation arm extends essentially diagonally to the locking arm.

7. The refuse container lock according to claim 1, characterized by a rotary axis that is immovably linked to the lock housing and about which the latch is rotatably mounted.

8. The refuse container lock according to claim 1, wherein the actuation slide can be moved parallel to the direction in which the opening slide fed in the lock housing moves.

9. The refuse container lock according to claim 1, wherein the actuation slide can be slid by the locking cam, which is configured as an excenter cam, contrary to the force of a spring.

10. The refuse container lock according to claim 1, wherein the opening slide and actuation slide are fed alongside one another in the lock housing, for which purpose two housing shells that configure the lock housing form guide ribs.
